(19) United States
(12) Patent Application Publication
(10) Pub. No.: US 2012/0188756 A1
(43) Pub. Date: Jul. 26, 2012

(54) PORTABLE LED TUBE LIGHT

(75) Inventors: Bradley Robert Kokoski, Fort Mill, SC (US); Steven J. Hahn, Lake Wylie, SC (US)

(73) Assignee: Jameson LLC, Clover, SC (US)

(21) Appl. No.: 13/437,505

(22) Filed: Apr. 2, 2012

Related U.S. Application Data
(63) Continuation-in-part of application No. 12/472,978, filed on May 27, 2009.

(51) Int. Cl. F21V 13/04; F21V 5/04

(52) U.S. Cl. 362/217.05; 362/217.02

(57) ABSTRACT

A work light including an elongated housing having a handle portion carrying work light controls, and a light-emitting portion including a plurality of electrically interconnected light-emitting diodes (LEDs) mounted on a substrate mechanically and thermally coupled with a heat sink, wherein the plurality of LEDs include at least two independently controllable groups of LEDs. The work light further includes a power cord electrically extending therethrough for connecting multiple lights in series.

### CROSS-REFERENCE TO RELATED APPLICATION

This application is a continuation-in-part (CIP) application claiming priority to U.S. application Ser. No. 12/472,978 filed May 27, 2009, the contents of which are incorporated by reference herein.

### TECHNICAL FIELD AND BACKGROUND OF THE INVENTION

This invention relates generally to a light-emitting diode (LED) work light, and more particularly, to a work light including an elongated tubular housing defining a handle portion carrying light controls, and a light portion including independently controllable groupings of colored LEDs thermally coupled to a heat sink. The light further includes a power cord electrically extending therethrough for powering the light and connecting multiple lights in series to provide a lighting network.

Portable and reliable work lights are essential for use in various applications, and are critical for use in military applications including mobile shelters, modular command posts and maintenance tents, among others. In these applications, the lights must not only be reliable and rugged, but must also not interfere with equipment that may be sensitive to low-frequency magnetic fields. Further, desirable lights should consume small amounts of power for operation, have a long lifespan, be resistant to temperature variations and vibration, and be readily interconnectable to assemble and take down lighting networks as desired.

### SUMMARY OF THE INVENTION

Therefore, it is an object of the invention to provide a work light including an electronic light source that is reliable, rugged, and resistant to temperature variations and vibration.

It is another object of the invention to provide a work light that is especially applicable for military use.

It is another object of the invention to provide a work light that does not interfere with the performance of equipment that may be potentially sensitive to low-frequency magnetic fields.

It is another object of the invention to provide a work light that is relatively lightweight and impact resistant.

It is another object of the invention to provide a work light that includes various colors of LEDs for emitting various colors of light.

It is another object of the invention to provide a heat management system for carrying heat away from the LEDs to prevent failure and increase life span.

It is another object of the invention to provide a work light including an LED control system for independently controlling the groups of colored LEDs and their intensity.

It is another object of the invention to provide a work light including a power cord electrically extending therethrough for connecting work lights in series to provide a lighting network.

It is another object of the invention to provide a master/slave lighting network including multiple LED work lights.

It is another object of the invention to provide a remotely controlled lighting network.

These and other objects of the present invention are achieved in the preferred embodiments disclosed below by providing a portable LED work light including an elongated housing having a handle portion carrying the work light controls and a light-emitting portion including a plurality of electrically interconnected light-emitting diodes (LEDs) mounted on a substrate mechanically and thermally coupled with a heat sink, wherein the plurality of LEDs include at least two independently controllable groups of LEDs. The work light further includes a power cord electrically extending through the housing terminating at opposed ends in electrical connectors for connecting multiple work lights in series.

According to another embodiment, the at least two independently controllable groups of LEDs include a first group of LEDs of a first color, for example white-colored LEDs, and a second group of LEDs of a second color, for example blue-, green-, red- etc.—colored LEDs, and the light controls are operable for independently powering on/off the at least two groups of LEDs.

According to yet another embodiment, the heat sink includes a body that corresponds to the shape of the substrate and further includes a plurality of fins that project outwardly from the body away from the plurality of LEDs.

According to yet another embodiment of the invention, a work light is provided including a housing defining a handle for gripping and manipulating the work light, a light-emitting portion including at least one light-emitting diode (LED) mounted on a substrate mechanically and thermally coupled with a heat sink operable for dissipating heat generated during the operation of the at least one LED, the heat sink including a body portion in full-face contact with the substrate and a plurality of fins extending outwardly away from the body and the at least one LED and defining air gaps therebetween, a light control system carried by the handle operable for powering on/off the at least one LED, a transparent cover for protecting the at least one LED from damage, and a power cord adapted for being connected to a power source to supply electrical power to the work light.

According to yet another embodiment of the invention, a lighting network for a military application is provided including a plurality of interconnected work lights, wherein each work light includes an elongated housing having a handle portion carrying work light controls and a light-emitting portion including a plurality of electrically interconnected light-emitting diodes (LEDs) mounted on a substrate mechanically and thermally coupled with a heat sink, wherein the plurality of LEDs include at least two independently controllable groups of LEDs, and a power cord electrically extending through the housing terminating at opposed ends in electrical connectors for connecting multiple work lights in series.

According to yet another embodiment of the invention, the lighting network is remotely controlled.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of a portable LED work light according to one embodiment of the invention;

FIG. 2 is an exploded perspective view of the LED work light of FIG. 1 for clarity;

FIG. 3 is a sectional view of a planar LED arrangement and corresponding heat sink according to one embodiment of the invention;

FIG. 4 is a sectional view of a planar LED arrangement and corresponding heat sink according to another embodiment of the invention;

FIG. 5 is a sectional view of an angled LED arrangement and corresponding heat sink according to another embodiment of the invention;

FIG. 6 is a sectional view of a partial annular LED arrangement and corresponding heat sink according to another embodiment of the invention;

FIG. 7 is a diagram depicting the relationship between light intensity and distance from the light source;

FIG. 8 is a top plan diagram depicting the relationship between luminance and distance from the light source;

FIG. 9 is a diagram depicting the LED control system according to one embodiment of the invention;

FIG. 10 is a diagram depicting a master/slave LED work light lighting network;

FIG. 11 is a diagram depicting a remotely controlled LED work light lighting network;

FIG. 12 is a sectional view of a planar LED arrangement including a generally planar lens;

FIG. 13 is a schematic diagram showing AC and DC power supply configurations for the LED light fixture;

FIG. 14 is a schematic diagram showing a back-up power supply configuration for the LED light fixture; and

FIGS. 15-18 are graphs showing acceptable levels of electromagnetic emissions of the LED light established for various military applications.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

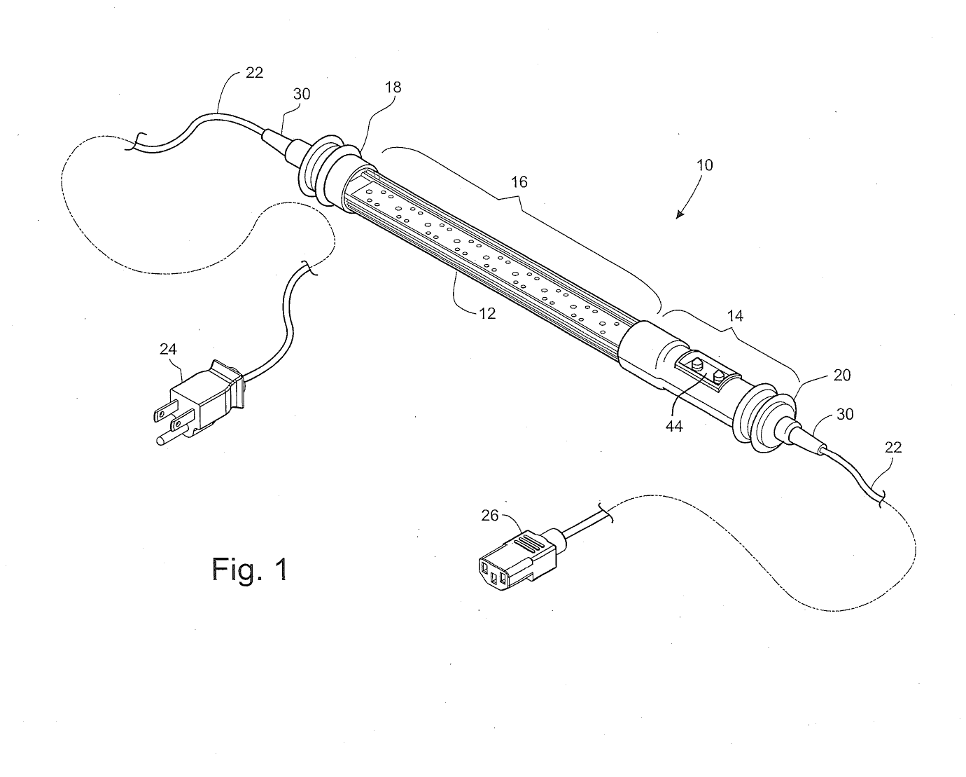

Referring now to the drawings, a portable LED work light according to the present invention is illustrated in FIG. 1 and shown generally at reference numeral 10. The LED work light 10 has particular application for military use in special purpose tents, modular command post units (MCPU), and other mobile military shelters, such as lightweight maintenance enclosures (LME), as well as other applications. Preferably, the work light 10 is lightweight, rugged and may be manufactured in any desired length.

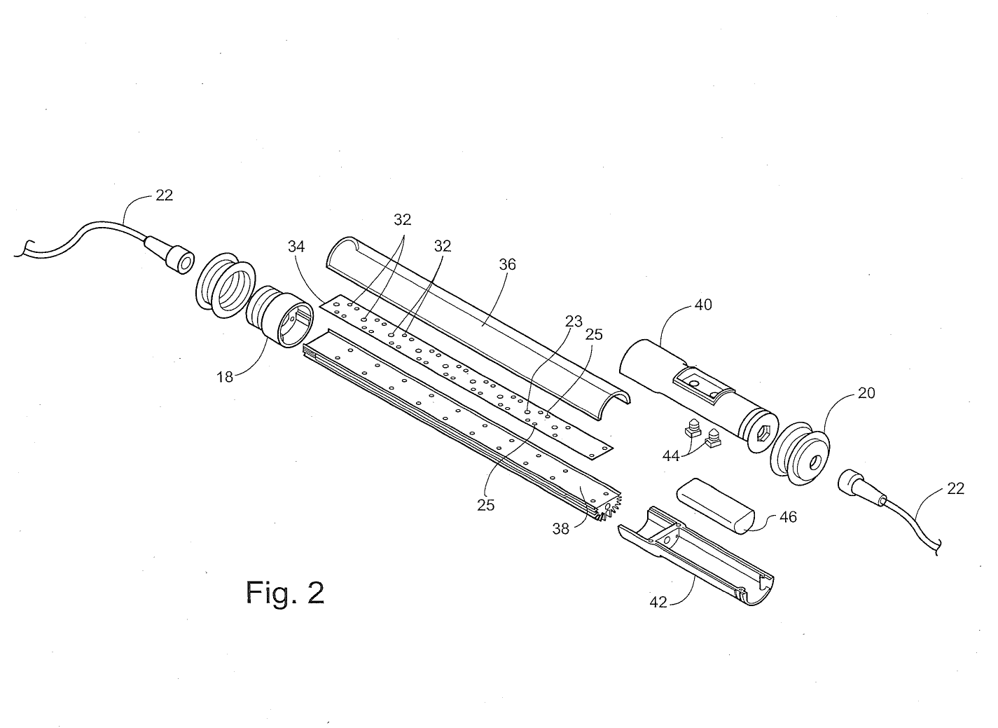

Referring specifically to FIGS. 1 and 2, the LED work light 10 includes a generally elongated tubular housing 12 including a handle portion 14 for manipulating the work light, and a light-emitting portion 16. Light controls 44 are carried on the handle portion 12, and are, preferably recessed from the exterior of the handle to prevent accidental activation. The handle and light-emitting portions 12 and 14 are positioned intermediate first and second end caps 18 and 20, respectively, that function to maintain the light components together. The end caps 18 and 20 further define annular protection rings of material that extend outwardly from the surface of the end caps beyond the surface of the tubular housing 12, thus protecting the handle and light-emitting portions 12 and 14 against impact damage, such as from dropping. The housing 12, end caps 18 and 20, handle 14 and select components of the light-emitting portion are preferably constructed from high-impact plastics and other shock-absorbing materials. According to one embodiment the end caps 18 and 20 are formed of an injection molded or extruded, medium hardness thermoplastic elastomer, such as polyolefin.

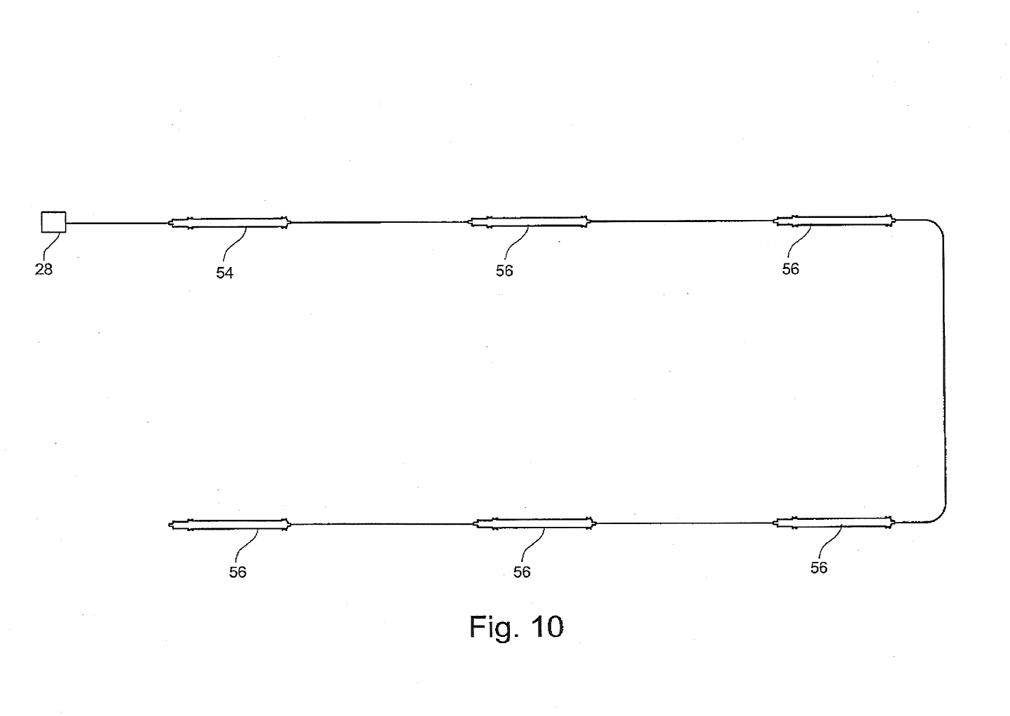

A power cord 22 electrically extends through the work light 10 and terminates at each end in respective mate and female connectors 24 and 26. The power cord 22 is operable for supplying power to a single light from a power source (see FIG. 10 at 28), such as a 120V or 230V AC power supply, or for providing power to multiple lights 10 connected in series to form a lighting network. The exemplary connectors shown are conventional keyed male and female connectors including a ground. Flexible cable boots 30 are provided about the engagement point with tubular housing 12 for strain relieving the power cord 22. The power cord 22 may have any desired length, and may have more length at one end compared to the other. The light-emitting portion 14 may have any desired length, and preferably corresponds to the number of LEDs. The diameter of the tubular housing 12 is preferably from about less than 1 inch to several inches in diameter.

The light-emitting portion 14 of the LED work light 10 includes a plurality of LEDs 32. The LEDs may vary in color and may be arranged in groups, groups of colors, or randomly arranged in terms of both numbers and colors. In a preferred embodiment, the LED colors include white (broad spectrum) and blue (about 450-500 nm), and are arranged to include a row of blue LEDs 23 positioned intermediate two rows of white LEDs 25. In an alternative embodiment, the LEDs may be any color including, but not limited to, green, blue, red and white. The rows of LED lights as shown are arranged parallel to the longitudinal axis of the light 10. As known to those skilled in the art, blue LED color is typically produced using zinc selenide, indium gallium nitride, silicon carbide, and silicon semiconductor materials, and white LED color is produced using blue/UV diode with yellow phosphor semiconductor material, although other materials are envisioned. In one embodiment, the LEDs are low output millimeter LEDs requiring a low driving current and having a lumens output to be visible from less than several hundred feet. Forward current is preferably limited to the nominal rated value of the LEDs to prevent overheating of the diode junction and premature failure.

As shown in FIG. 2, the LEDs 32 are arranged and mounted on a front surface of a planar substrate 34, such as a metal substrate. The plurality of LEDs 32 are interconnected through conductive pathways and are electrically coupled with a circuit board preferably located in the handle portion 14 of the tubular housing 12. The substrate 34 is preferably reflective to direct light away from its surface and outward through a protective, optically transparent cover 36. As shown, the transparent cover 36 comprises about one-half of the circumference of the tubular light-emitting portion 16 of the work light 10. The transparent cover 36 may be constructed from polycarbonate or acrylic materials advantageously chosen for their temperature resistance, impact resistance and optical properties. The transparent cover 36 is preferably shaped to define an air gap between its inner surface and the LEDs 32. The transparent cover 36 may optionally include a lens for focusing or directing the light emitted from the LEDs 32.

The back surface of the substrate 34 is mechanically and thermally coupled to a heat sink 38 operable for carrying heat away from the LEDs 32 and dissipating the heat. The heat sink 38 is uncovered and exposed to facilitate cooling, thus the heat sink 38 defines a portion of the surface of the tubular housing 12. Mechanical fastening of the substrate 34 and heat sink 38 may be accomplished through high-temperature adhesive or conventional fasteners. The heat sink 38 preferably defines a surface in full-face contact with the substrate 34 that corresponds to the shape of the substrate 34, thus effectively, efficiently and uniformly transferring heat from the LEDs 32. A heat sink 38 is required as LED performance largely depends on the ambient temperature of the operating environment. Over-driving the LEDs 32 in high ambient temperatures may result in overheating of the LED package, eventually leading to device failure. Thus, adequate heat sinking is required to maintain long life and is especially important when considering military applications where the device must operate over a large range of temperatures and is required to have a low failure rate.

The handle portion 14 of the work light 12 includes first and second housing components 40 and 42 that engage each other to define the handle. The light controls 44 as shown are carried by the first component 40, and the circuit board 46 is maintained within a cavity defined between the components 40 and 42. The light controls 44 are accessible through a recess panel defined in the handle portion 14 to allow actuation while preventing unintentional depressing. The light controls 44, described in more detail below, are preferably marked with indicia such as color or text to indicate the function of each control. Although not shown, the light 10 may optionally include a battery back-up or capacitor to continue operation in the event of a power outage. As known to those skilled in the art, the light controls 44 open and close circuits on the circuit board 46 to power on/off the light(s) and change intensity.

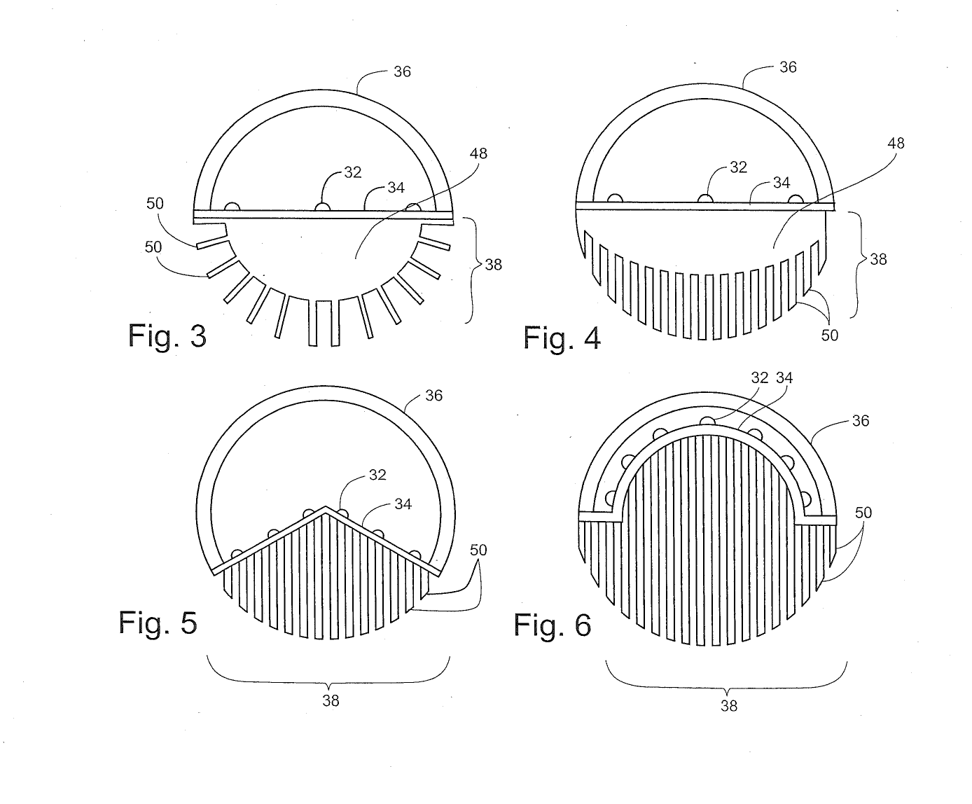

Referring to FIGS. 3-6, sectional views of various embodiments of heat sink assemblies suitable for use in the present invention are shown. Referring specifically to FIG. 3, a preferred embodiment of a heat sink 38 is shown and includes a semi-circular solid body 48 in contact with the substrate 34, and a plurality of fins 50 projecting radially-outward from the surface of the solid body 48. The plurality of fins 50 define air gaps therebetween for allowing heat from the LEDs 32 and substrate 34 to dissipate. The heat sink 38 may be constructed from any materials including, but not limited to, metals and polycarbonate. Referring to FIG. 4, an alternative embodiment of a heat sink 38 is shown for dissipating heat from a planar substrate 34. The heat sink 38 includes a plurality of fins 50 projecting laterally-outwardly from a solid portion 48 and the substrate 34. Referring to FIG. 5, the shape of the heat sink 38 corresponds to an angled substrate 34 and includes a plurality of fins 50 projecting laterally-outwardly from a lateral axis defined horizontally through the light 10. Thus, the fins 50 about each end of the heat sink 38 having a length less than the center fins. Further, the LED arrangement shown in FIG. 5 provides a greater lighting angle. Referring to FIG. 6, the shape of the heat sink 38 corresponds to the complex shape of the substrate 34, and defines laterally extending fins 50.

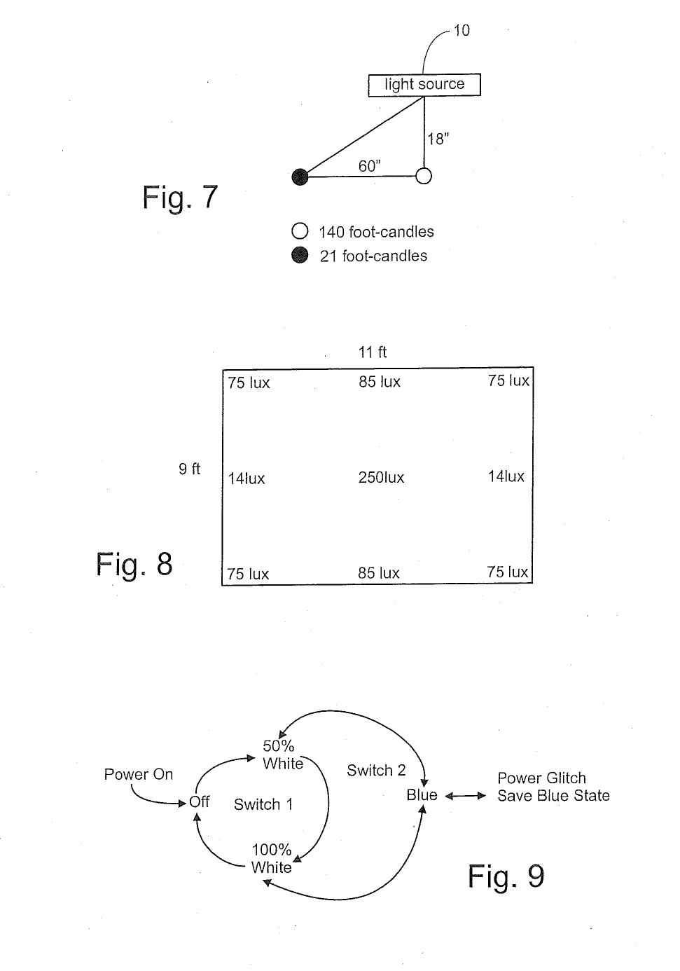

Referring to FIG. 7, a diagram depicting an exemplary relationship between light intensity and distance and angle from a particular work light 10 is shown. In one embodiment, the shape of the substrate 34, number of LEDs 32, LED size and current supplied may be optimized to receive approximately 140 foot-candles of light at a first distance of about 18 inches perpendicular, or directly beneath the light 10. Under the same configuration, only about 21 foot-candles of light are received at a distance of about 60 inches from the first distance and at an angle with respect to the light 10. Thus, the light emitted is directional.

Referring to FIG. 8, a top plan diagram depicting the relationship between luminance and distance from the light source is shown. As further supporting the diagram of FIG. 7, the luminance was measured from a central, overhead light source about 5 feet above an approximately 100 sq ft area. As can be seen, the area directly below the work light received the greatest amount of light, while areas further from the work light received lesser amounts of light.

Referring to FIG. 9, the preferred embodiment of the work light control system is shown. As stated above, the light preferably includes a predetermined number of white- and blue-colored LEDs in a predetermined arrangement, such as rows of LEDs. In a preferred embodiment, first and second controls are provided, wherein the first control is operable for powering the white LEDs on/off, as well as powering on a percentage of the total number of LEDs, such as 50% or 100%, by depressing the control additional times. The second control is operable for powering on/off the blue LEDs, and may optionally also control the percentage of LEDs powered. Thus, controls are provided for independent operation of various groups of LEDs. In an alternative control system, a master power on/off control may be provided, and additional controls provided for independently controlling groups of LEDs, current supplied thereto, and percentage of lights within colored groupings.

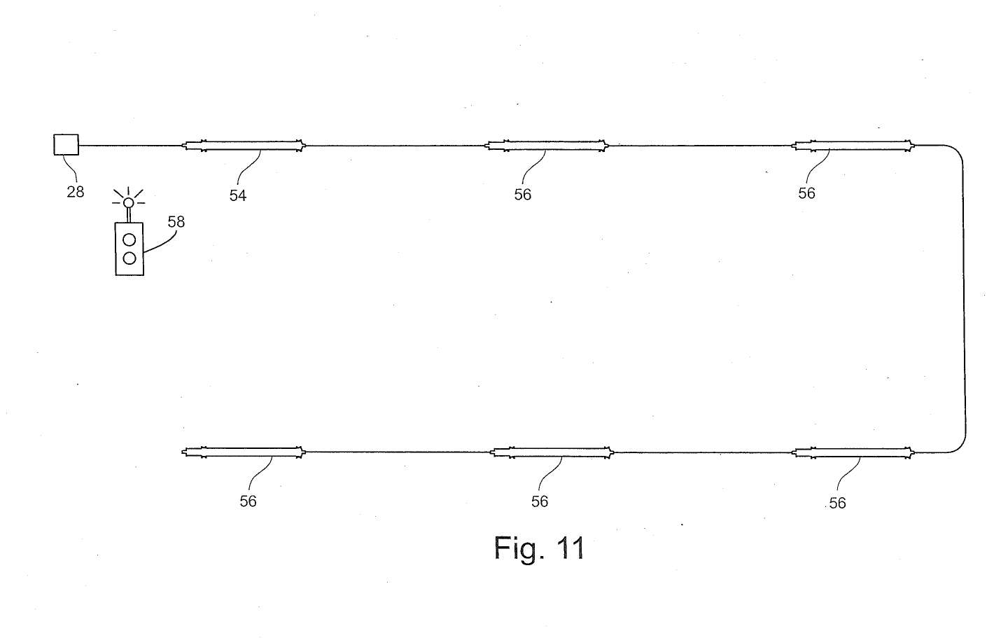

Referring to FIGS. 10 and 11, respectively, a master/slave LED work light lighting network and a remotely controlled lighting network are shown. The lighting networks include multiple work lights connected in series and located in predetermined locations. The lighting network includes a power supply 28 for supplying power to the lights. The lighting network includes a master light 54 and a predetermined number of slave lights 56 that are controlled by the master light controls. Thus, control of all white and blue LEDs in the network is controlled at a single light. Referring specifically to FIG. 11, the controls may be controlled through a remote controller 58 utilizing any conventional remote means known to those skilled in the art. In an exemplary application, the lighting network may be installed in a mobile shelter, wherein one or more of the work lights are suspended from overhead rods or straps to provide a convenient, energy efficient lighting system. The shelter system may be a military MCPU or LME, or any other such tent or enclosure.

Still referring to FIGS. 10 and 11, the lights 54 or 56 can be daisy-chained into a continuous string. The color mode or dimming function of all light fixtures in the same string can be changed simultaneously by actuating the mode buttons of any of the individual lights. Each light 54 or 56 incorporates the ability to recognize a signal propagation from any other light within the same string. In one embodiment, this can be accomplished by integrating a signal-carrying conductor within the cordset of each light fixture, allowing the signal to be passed along to all fixtures in the same string. The internal electronics of the light fixture can be connected to the signal conductor within the cordset, and are designed to recognize the signal and change the lighting function mode accordingly.

The signal generation for the illumination control may be accomplished in several ways. For example, it may be an on-board (to the fixture) component such as an integrated circuit that may either produce a signal if the switches of the fixture in which it resides are activated, or it may receive a signal from another integrated circuit in the string of fixtures in which it is a part. The signal may come from an external module that is placed anywhere in the string of fixtures, but is preferably located at either the beginning or end of the string. In this module, the control signal may be generated and that signal propagates through the string to the individual light fixture driver modules. It is also envisioned that the signal may come from a remote source such as an IR, RF or Bluetooth® transmitter. The transmitted signal can be received by either a central control module or any or all of the light fixtures that have a receiver imbedded/incorporated into its electronics.

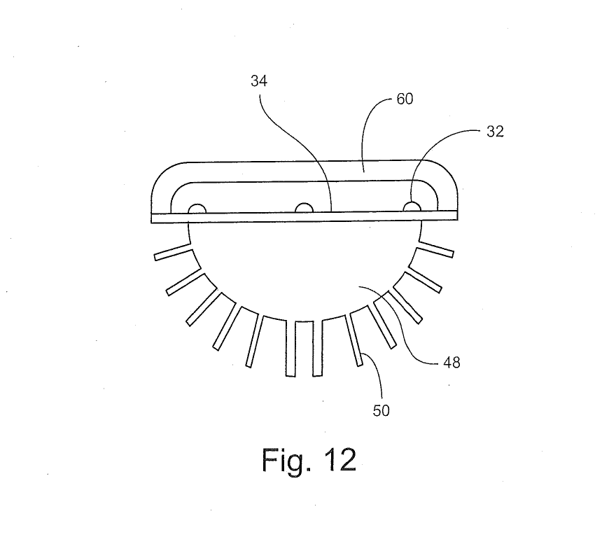

Referring to FIG. 12, another embodiment of a work light is shown and includes a generally planar lens 60 covering the plurality of LEDs 32. As with the embodiment shown in FIG. 3, the light of FIG. 12 includes a semi-circular solid body 48 in contact with the substrate 34, and a plurality of fins 50 projecting radially-outwardly from the surface of the solid body 48. The plurality of fins 50 define air gaps therebetween for allowing heat from the LEDs 32 and substrate 34 to dissipate. The heat sink may be constructed from any materials including, but not limited to, metals and polycarbonate.

For convenient assembly and disassembly, the components of the work light 10 include complementary snap-together attachment elements enabling ready access to and replacement of worn or damaged parts. In addition, all surface elements of the work light 10 are preferably non-conductive. The term non-conductive is defined as having sufficient dielectric to be considered non-conductive at voltages below 600V AC. The work light 10 may also include one or more hanger hooks (not shown) for suspending the light from overhanging support structure inside the tent or enclosure. In additional embodiments, the work light 10 may further include additional electronics to reduce EMI.

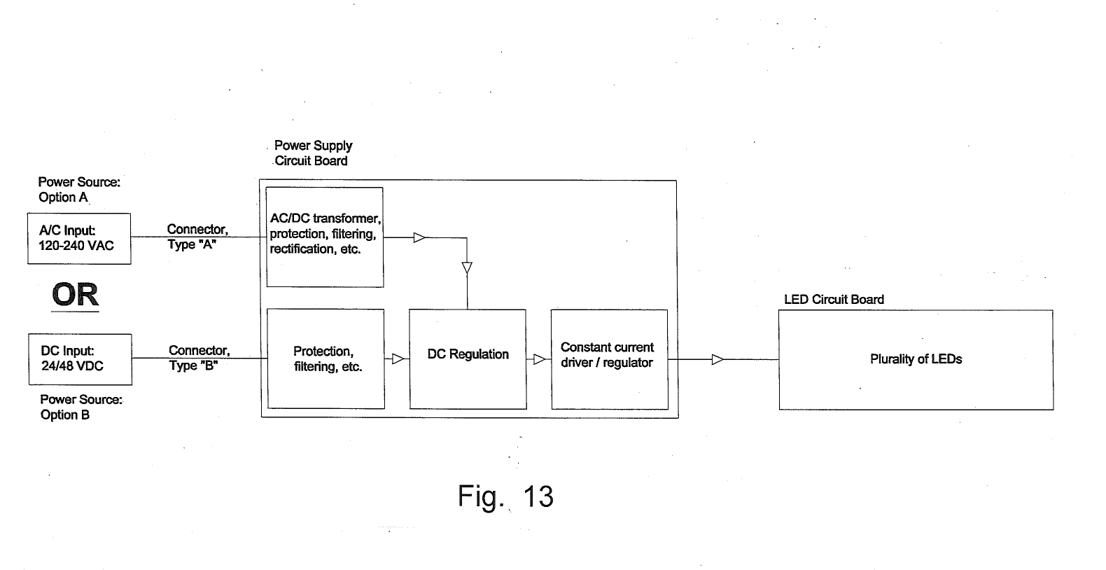

Referring to FIG. 13, the power supply of the LED work light 10 can be configured to accept either AC or DC input voltage by incorporating two separate input connectors, each allowing separate access to a dedicated circuit within the power supply, with one activating AC/DC conversion and the other activating DC/DC regulation. During assembly, one input connector or the other would be chosen, but not both. The configuration and assembly advantageously consolidates part number, reduces production lead times and optimizes inventory levels of the power supply components.

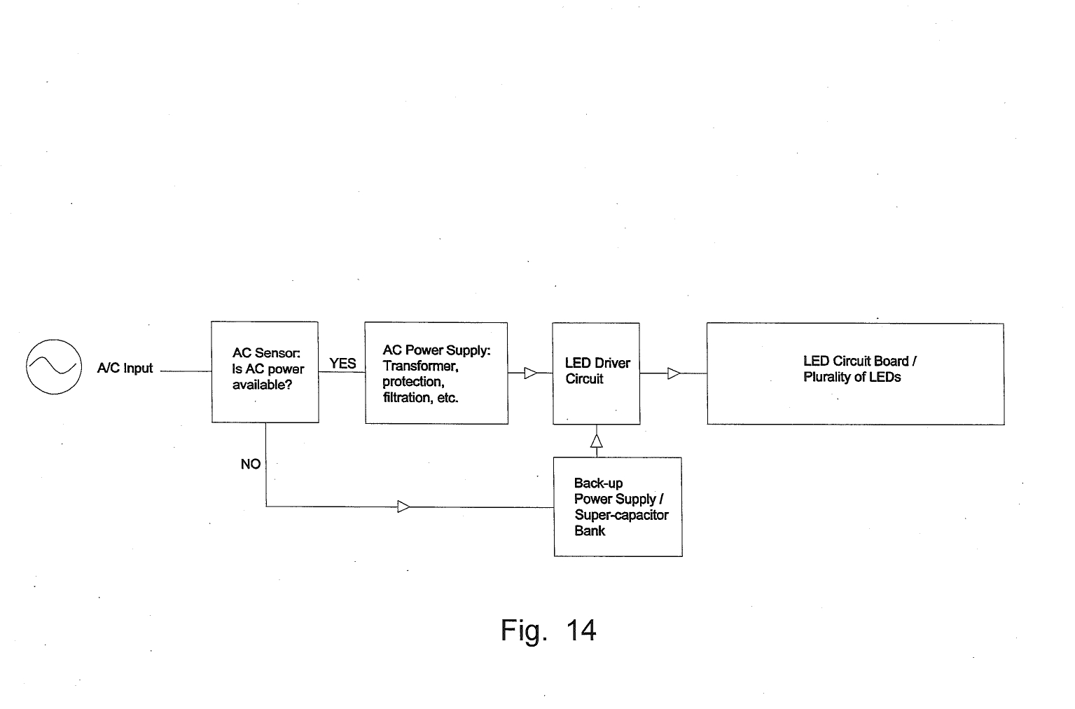

Referring to FIG. 14, the LED work light 10 and lighting system may include a back-up power supply emergency lighting function. The LED work light 10 may incorporate an emergency lighting function by the integration of a bank of super-capacitors and associated electronic controls. The super-capacitors are utilized as a back-up power supply in the event that the main power source is lost (e.g., power outage, loss of generator function, etc.). When power is lost, the super-capacitor power source is automatically activated so that low level lighting (e.g., 1 or 2 LEDs) becomes illuminated to facilitate safe maneuverability within the shelter or other structure. Low level lighting remains lit at a constant low power output for approximately 2-3 minutes while the super-capacitors discharge, or until main power is restored. When the main power is restored, the lights resumes their previous mode function and the super-capacitor bank automatically recharges.

A benefit of the super-capacitors is that they recharge quickly (e.g., in seconds or minutes) as compared to hours for standard power sources such as batteries. Super-capacitors also have a high power density, enabling a compact size as compared to lead acid or nickel-metal-hydride batteries. Super-capacitors further have no disposal or safety issues, and do not degrade over time if unused like most batteries.

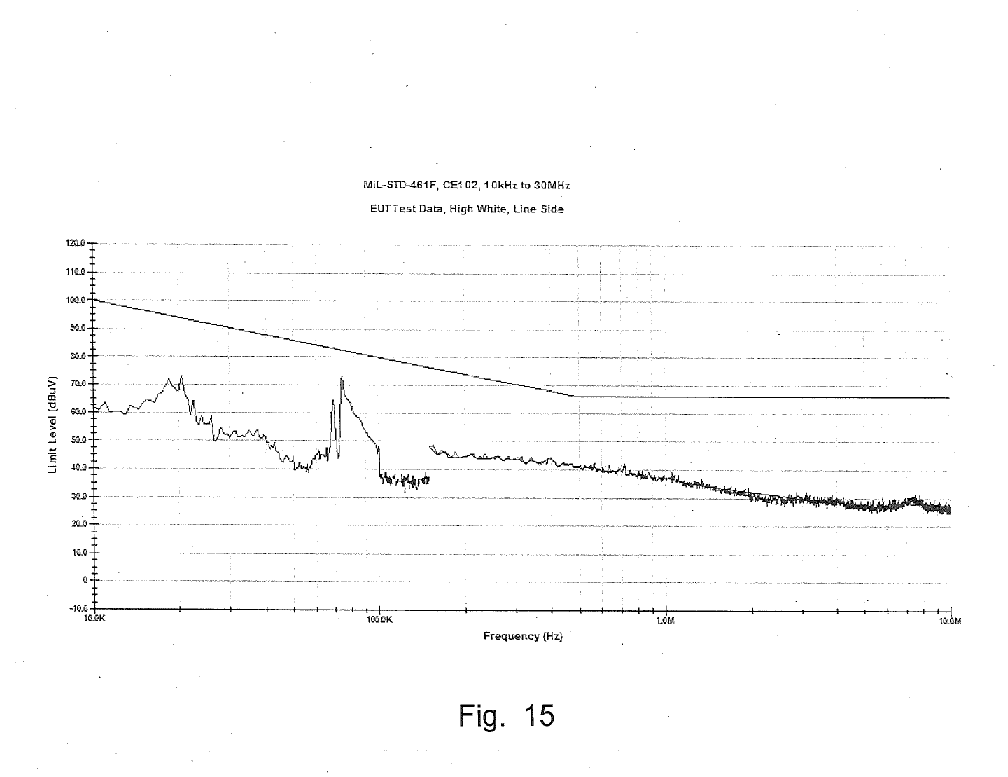

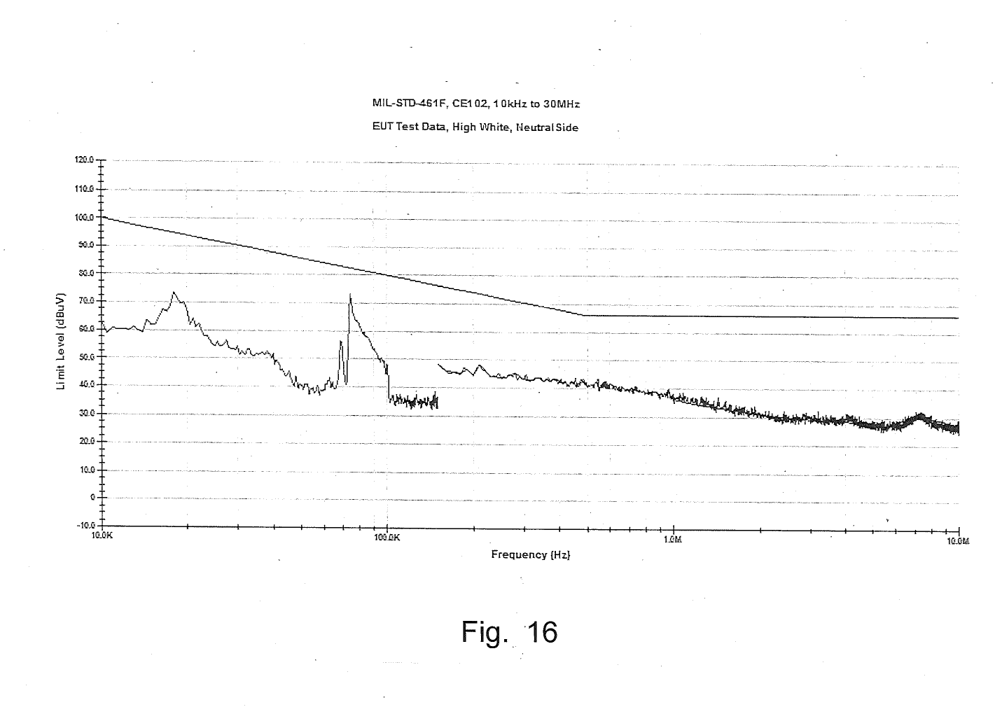

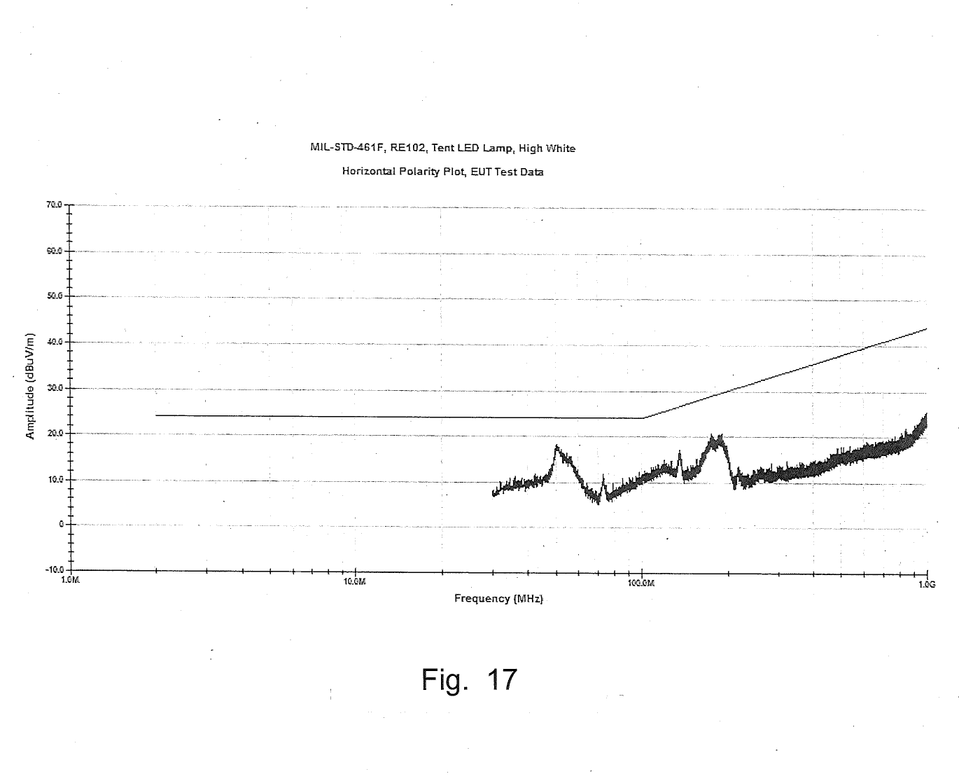

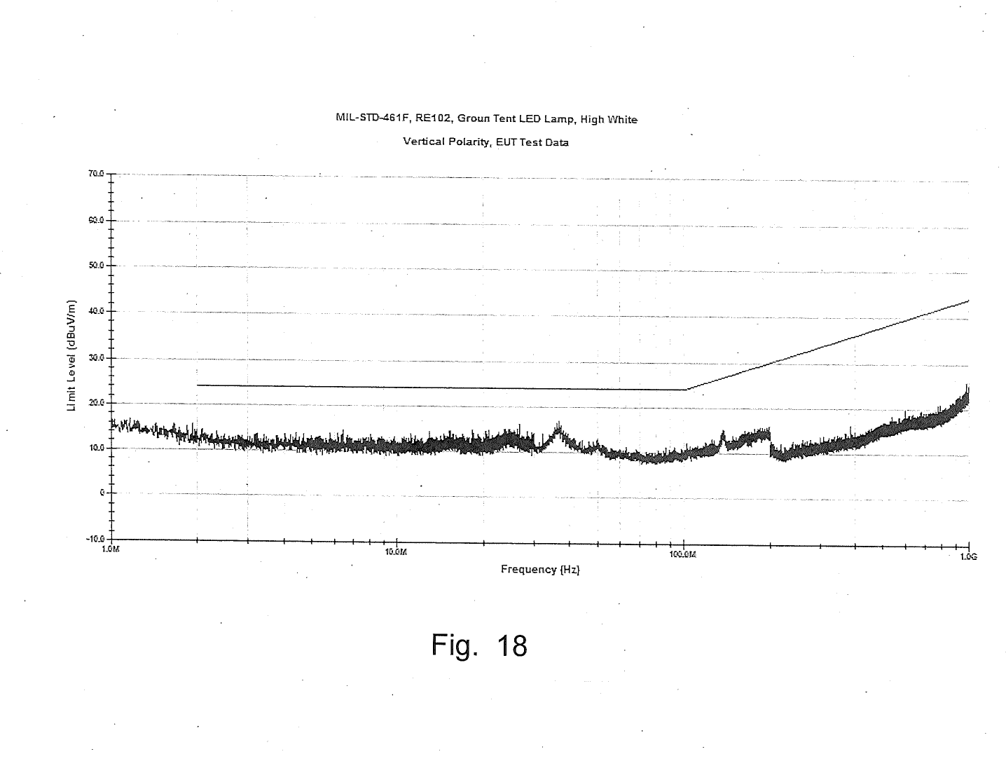

Referring to FIGS. 15-18, the LED work light electronics (i.e., power supply and LED light engine) are designed such that no excessive electromagnetic emissions are emitted above the levels set forth in MIL-STD-461, RE102 and CE102 for Army Ground applications. This is achieved by methods not limited to proper magnetic specification, ground plane design, line filtration and component shielding. This feature enables the LED work light 10 to operate normally while not interfering with adjacent critical electronics such as command/control/communications equipment or medical devices.

A portable LED work light is described above. Various details of the invention may be changed without departing from its scope. Furthermore, the foregoing description of the preferred embodiment of the invention and the best mode of practicing the invention are provided for the purpose of illustration only and not for the purpose of limitation—the invention being defined by the claims.

What is claimed is:

1. A work light, comprising:
(a) an elongated housing, comprising:
(i) a handle portion carrying work light controls; and
(ii) a light-emitting portion including a plurality of electrically interconnected light-emitting diodes (LEDs) mounted on a substrate mechanically and thermally coupled with a heat sink, the plurality of LEDs including at least two independently controllable groups of colored LEDs, and the heat sink including a planar attachment surface that corresponds to a planar surface of the substrate and a plurality of uncovered spaced-apart fins that project outwardly from the planar attachment surface and the LEDs, wherein distal ends of the fins collectively define a substantially semi-circular shape in vertical cross section;
(b) a power cord electrically extending through the housing terminating at opposed ends in electrical connectors for connecting multiple work lights in series; and
(c) an optically transparent, elongate cover lens enclosing the light-emitting portion of the housing, the cover lens having a pair of opposed sidewalls integrally formed with a planar transparent central lens element positioned between and in a recessed configuration in relation to the cylindrical handle portion and a shock-absorbing end cap.

2. The work light according to claim 1, further comprising an input connector for AC/DC conversion for an AC power source.

3. The work light according to claim 1, further comprising an input connector for DC/DC regulation for a DC power source.

4. The work light according to claim 1, further comprising a bank of super-capacitors located in the handle portion for powering a lesser number of LEDs than a total number of LEDs of the work light in an emergency lighting operational mode.

5. The work light according to claim 1, wherein the at least two independently controllable groups of colored LEDs include a first group of LEDs including white-colored LEDs, and a second group of LEDs including at least one of blue-, red- and green-colored LEDs.

6. The work light according to claim 1, wherein the light controls are operable for independently powering on/off the at least two groups of LEDs.

7. The work light according to claim 1, further comprising shock-absorbing end caps positioned about opposed ends of the housing and defining annular protection rings.

8. The work light according to claim 1, wherein the heat sink includes a body that corresponds to the shape of the substrate and further includes a plurality of fins that project outwardly from the body away from the plurality of LEDs.

9. The work light according to claim 1, wherein the substrate is reflective and defines a planar surface.

10. The work light according to claim 10, further comprising at least one of white-, blue-, red- and green-colored LEDs arranged in predetermined groups on the substrate.

11. The work light according to claim 10, wherein the light controls independently power on or off the predetermined groups of LEDs.

12. The work light according to claim 10, wherein the light controls power on or off a percentage of lights within the predetermined groups of LEDs.

13. The work light according to claim 1, wherein the shock-absorbing end cap defines annular rings projecting therefrom.

14. The work light according to claim 1, wherein the power cord electrically extends through the work light and terminates at opposed ends in corresponding male and female electrical connectors to permit multiple work lights to be electrically connected in series.
